(19) United States
(12) Patent Application Publication
(10) Pub. No.: US 2002/0089784 A1
(43) Pub. Date: Jul. 11, 2002

(54) Magnetic tape apparatus

(75) Inventor: Satoshi Unno, Tokyo (JP)

Correspondence Address: SUGHRUE MION, PLLC, 2100 Pennsylvania Avenue, NW, Washington, DC, 20037-3213, US

(73) Assignee: NEC CORPORATION

(21) Appl. No.: 10/013,483

(22) Filed: Dec. 13, 2001

(30) Foreign Application Priority Data
Dec. 20, 2000 (JP) 2000-386586

(51) Int. Cl. G11B 5/41

(52) U.S. Cl. 360/128

(57) ABSTRACT

The magnetic tape apparatus is provided with: a magnetic head for writing/reading a predetermined data to/from a magnetic tape 1; a driving mechanism 2 for driving the magnetic tape 1; a blade member 4 for cleaning a surface when coming in contact with the magnetic tape 1; and a blade moving mechanism 5 for holding this blade member 4 and further moving the blade member 4, irrespectively of a condition that the blade member 4 is in contact with the magnetic tape 1 or it is not in contact.

### BACKGROUND OF THE INVENTION

1. Field of the Invention

The present invention relates to a magnetic tape apparatus, and more particularly relates to a magnetic tape apparatus having a function of cleaning a magnetic tape while it is driven.

2. Description of the Related Art

Conventionally, most of the magnetic tape apparatuses used in a computer device use a tape manufactured by a coating method (for example, DAT and the like). In this coating method, it contains magnetic powder and adhesive material referred to as a binder, in order to adhere the magnetic powder onto the tape. Thus, there may be a case that the magnetic powder and the binder are stripped from the tape, which results in contaminants. Also, dust coming from an external portion of the magnetic tape apparatus may be deposited on the magnetic tape, which results in contaminants.

So, the above-mentioned contaminants deposited on a magnetic head may cause a trouble, such as a disabled writing/reading operation and the like, to be induced in the magnetic tape apparatus. In order to cope with such problems, a magnetic tape apparatus including a mechanism for cleaning the contaminants from the magnetic tape (the tape cleaning mechanism typically referred to as a blade) has been conventionally known as shown in FIG. 4. The magnetic tape apparatus including the tape cleaning mechanism according to the conventional example will be explained with reference to FIG. 4.

FIG. 4 is a schematic view showing the configuration of the magnetic tape apparatus according to the conventional example. This magnetic tape apparatus is provided with: a magnetic head (not shown) for writing/reading a predetermined data to/from a magnetic tape 11; a driving mechanism 12 for driving the magnetic tape 11; guide pins 13 for guiding the magnetic tape 11 to the magnetic head; and tape cleaning mechanisms 14, 15 fixed within the apparatus. The tape cleaning mechanisms 14, 15 are composed of a blade member 4 and a blade member fixing unit 15, and the blade member is mounted so as to be in contact with a surface of the running magnetic tape 11.

Due to such configuration, as shown in FIG. 4, the magnetic tape 11 is hung on the respective guide pins 13 in the magnetic tape apparatus, and the blade member 14 comes in contact with a tape surface (the data writing/reading plane). Thus, for example, when the magnetic tape 11 is driven to a forward direction shown in FIG. 4, the movement of the magnetic tape 11 to the forward direction enables a contaminant 16 deposited on the tape surface and the like to be cleaned (shaven off) by the blade member 14. Hence, the contaminant 16 and the like are removed from a portion where the writing/reading operation is carried out by the magnetic head of the magnetic tape 11. Therefore, it is possible to suppress an occurrence of a writing/reading error caused by the contaminant 16 and the damage to the magnetic head.

However, the conventional technique has the following defect. That is, the blade member is fixed with respect to the magnetic tape. Thus, the contaminant shaven off when the magnetic tape is driven to the forward direction is again deposited on the magnetic tape because of the movement to a reverse direction. Thus, if the tape is wound in the condition that the contaminant is deposited, the contaminant is put between the wound tapes. This brings about a condition of the pressed contaminant, which has a bad influence on data recorded on the magnetic tape.

The present invention is proposed in view of the above-mentioned circumstances. It is therefore an object of the present invention to provide a magnetic tape apparatus, in which it is especially possible to prevent the contaminant, which is once shaven off from the magnetic tape, from being again deposited on the magnetic tape, and also possible to prevent the writing/reading error from being induced in the magnetic tape, and further possible to prevent the magnetic tape or the magnetic head from being damaged.

### SUMMARY OF THE INVENTION

So, the present invention employs the configuration including: a magnetic head for writing/reading a predetermined data to/from a magnetic tape; a driving mechanism for driving said magnetic tape; a blade member for cleaning a surface of the magnetic tape; and a blade moving mechanism for holding this blade member and further moving the blade member so as to contact/detach with/from said magnetic tape. Here, preferably, the blade member is made of a hard material.

The moving direction of the blade member by the blade moving mechanism is desired to be a direction in which the blade member carries out a reciprocating motion against to a surface of the magnetic tape. Moreover, when the magnetic tape is driven to a predetermined direction, the blade moving mechanism may be operated to push the blade member so that the blade member comes in contact with the magnetic tape. When the magnetic tape is driven to a direction opposite to the predetermined direction, it may be operated to pull the blade member so that the blade member is detached from the magnetic tape.

Also, it is desirable that the blade moving mechanism is composed of a solenoid which is moved when a predetermined power supply is turned on and off and that the predetermined power supply is turned on and off on the basis of the running direction of the magnetic tape.

Due to such configuration, when the magnetic tape is driven to a predetermined direction, for example, a forward direction, the blade member is pressed by the blade moving mechanism so that it comes in contact with the magnetic tape. Then, the run of the magnetic tape causes the contaminant deposited on the tape surface to be shaven off by the blade member. After that, the writing/reading operation is performed on the magnetic tape, from which the contaminant is removed, through the magnetic head. Then, the magnetic tape is wound up. Also, when the magnetic tape is driven to a reverse direction, the blade member is pulled by the blade moving mechanism, and detached from the magnetic tape. Thus, even if the shaven contaminant and the like are deposited on the blade member, it is possible to prevent the contaminant from being again deposited on the magnetic tape.

Thus, the deposited sediments such as the contaminant and the like are removed from the magnetic tape when the writing/reading operation is performed on the magnetic tape by the magnetic head, or when the magnetic tape is wound up. Hence, it is possible to prevent an occurrence of a recording/reproducing error caused by the contaminant and the like. Moreover, a case is reduced in which the magnetic tape is wound up while the contaminant and the like are put between the tapes. Therefore, it is possible to prevent the magnetic tape from being damaged.

Also, it may be designed that two blade members and two blade moving mechanisms are arranged close to the magnetic tape. The two blade moving mechanisms are operated such that only one blade member of the two blade members comes in contact with the magnetic tape, depending on the running direction of the magnetic tape. Accordingly, when the magnetic tape is driven to the forward direction, one blade member comes in contact with the magnetic tape. When it is driven to the reverse direction, the other blade member comes in contact with the magnetic tape. Thus, whether the magnetic tape is driven to the forward or reverse direction, it is possible to clean the magnetic tape. Moreover, if the magnetic tape is driven to a direction opposite to the direction when the contaminant is removed, the blade member is detached from the magnetic tape. Hence, it is possible to prevent the once removed contaminant from being again deposited on the tape.

### BRIEF DESCRIPTION OF THE DRAWINGS

FIG. 1 is a schematic view showing a configuration of an embodiment of the present invention;

FIG. 2 is an explanation view showing an example of a predetermined operation in an embodiment of the present invention disclosed in FIG. 1;

FIG. 3 is a schematic view showing a configuration of second embodiment of the present invention; and

FIG. 4 is a schematic view showing a configuration of a magnetic tape apparatus according to a conventional example.

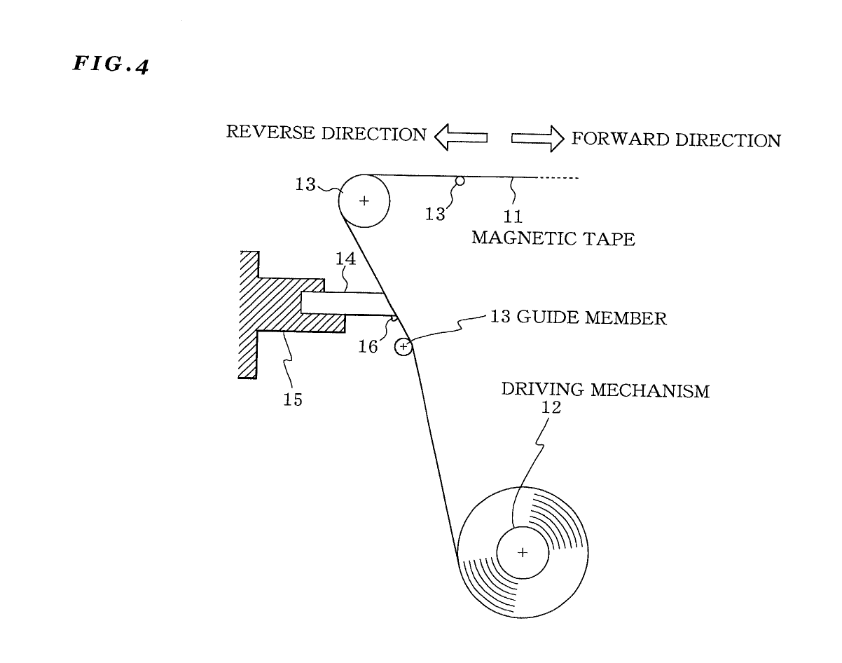

### DETAILED DESCRIPTION OF THE PREFERRED EMBODIMENTS

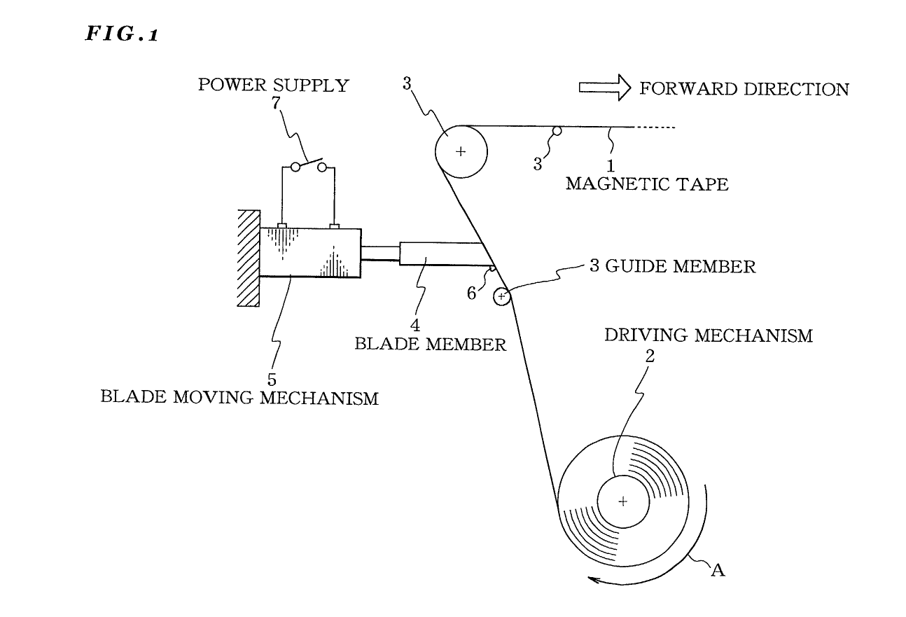

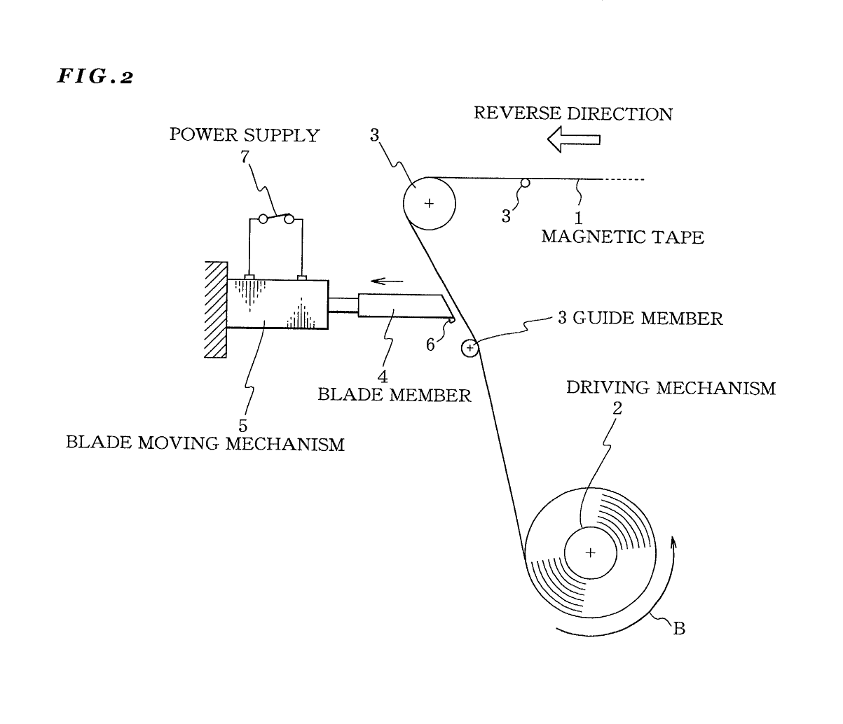

An embodiment of the present invention will be explained below with reference to FIGS. 1, 2.

FIG. 1 is a schematic view showing a configuration of an embodiment of a magnetic tape apparatus according to the present invention. This magnetic tape apparatus is provided with: a magnetic head (not shown) for writing/reading a predetermined data to/from a magnetic tape 1; a driving mechanism 2 for driving the magnetic tape 1; and a guide member 3 for guiding the magnetic tape 1 to the magnetic head.

Moreover, it has a blade member 4, which is located close to the magnetic tape 1, for cleaning a surface of the magnetic tape 1 when coming in contact with the magnetic tape 1, and a blade moving mechanism 5 for holding this blade member 4 and further moving the blade member 4 irrespectively of the condition that the blade member 4 is in contact/detach with/from the magnetic tape 1.

This will be described below in detail.

The magnetic tape 1 is a magnetic tape such as, for example, DAT and the like, which is used in a computer device. It is the magnetic tape 1 that uses a coating type containing magnetic powder and adhesive material referred to as a binder for adhering the magnetic powder onto the tape. However, the magnetic tape 1 is not limited to the DAT. A predetermined track is formed on a recording surface of the magnetic tape 1. So, a predetermined information is magnetically read/written from/on a main data area of this track by the magnetic head.

Here, the magnetic powder and the adhesive material referred to as the binder for adhering it onto the tape are included in the magnetic tape 1 as mentioned above. Thus, they may be stripped from the tape, which results in contaminants. Also, dusts coming from an external portion of the magnetic tape apparatus may adhere to the magnetic tape 1.

The magnetic head (not shown) is arranged at a predetermined position of the magnetic tape apparatus, and the track of the magnetic tape 1 is scanned by the magnetic head. At a time of a scanning operation, the predetermined information is written on the magnetic tape 1 by the magnetic head, or an already-stored information is read out by the magnetic head. Moreover, a plurality of magnetic heads may be installed.

The driving mechanism 2 is a mechanism for driving the magnetic tape 1 to a predetermined direction or a direction opposite to the predetermined direction, namely, it is a mechanism for sequentially sending the recording surface of the magnetic tape 1 to the magnetic head. For example, it is composed of an S reel for winding the magnetic tape 1. Accordingly, a magnetic tape 2 is wound from one S reel to the other S reel. Thus, the magnetic tape 2 is driven. As a result, the recording surface thereof is sequentially sent to the magnetic head.

A plurality of guide members 3 are arranged at predetermined positions of the magnetic tape apparatus, and they have a function of guiding the magnetic tape 1 to the magnetic head. Each guide member 3 is composed of, for example, a roller, a pin and the like. Then, the magnetic tape 1 is hung on the guide member 3 to thereby be sent to the magnetic head without any twist.

The blade member 4 is a bar-shaped member, in which one end thereof is held by the later-described blade moving mechanism 5 and the other end thereof is oriented toward the magnetic tape 1. Also, this blade member 4 is made of hard material, such as ceramic, sapphire and the like, and the other edge thereof has a shape of a sharp blade.

The sharp blade portion, which is located at other end of this blade member 4, comes in contact with the running magnetic tape 1 to thereby shave off the above-mentioned contaminant 6 deposited on the magnetic tape 1. The contaminant 6 shaven off from the magnetic tape 1 may be kept at the condition that it is deposited on the blade member 4, or it may be dropped from the blade member 4. Accordingly, the magnetic tape 1 from which the contaminant 6 is removed is fed to the magnetic head. Thus, it is possible to prevent an occurrence of a reading/writing error of the magnetic head.

The blade moving mechanism 5 for holding the blade member 4 and further moving the blade member 4 to and from the surface of the magnetic tape 1 is fixed at a predetermined position of the apparatus, and it is composed of a solenoid. That is, in the blade member 4, the one end thereof is connected to the solenoid.

The solenoid is designed such that a coil is wound around a movable iron core, and a magnetic field generated in the coil when a current flows through the coil causes the movable iron core to be pulled into a center of the coil or to be pulled out to an outer side. Thus, this solenoid is moved when a predetermined power supply 7 is turned on and off, and the blade member 4 is also moved in association with this movement.

Also, the on/off operation of the power supply 7 of the solenoid is linked with the running direction of the magnetic tape 1, namely, the power supply 7 of the solenoid is switched depending on the change in the rotation direction of the S reel serving as the driving mechanism 2.

Here, this embodiment is designed as follows. That is, when the magnetic tape 1 is driven to a forward direction shown in FIG. 1, the power supply 7 of the solenoid is off. When the magnetic tape 1 is driven to a reverse direction as shown in FIG. 2, the power supply 7 is on. When this power supply 7 is on, the blade member 4 is pulled by the solenoid so that the blade member 4 is detached form the magnetic tape 1. Thus, the blade moving mechanism 5 according to this embodiment is composed of the pull side solenoid.

However, the blade moving mechanism 5 is not limited to the above-mentioned solenoid. It may be a push type solenoid for pushing out the blade member 4 when the power supply is turned on. Even if it is not the solenoid, it may have a mechanism for moving the blade member 4 irrespectively of the condition that the blade member 4 is in contact with the magnetic tape 1 or it is not in contact. Thus, the blade moving mechanism 5 is not limited to a type, in which the blade member 4 is moved by switching an electric signal on the basis of the running direction of the magnetic tape 1. The blade moving mechanism 5 may be a mechanism for mechanically moving the blade member 4 in accordance with the change in the running direction of the magnetic tape 1 so that the blade member 4 is detached from the magnetic tape 1.

The operation of this embodiment will be described below.

At first, when the S reel serving as the driving mechanism 2 is rotated to a direction indicated by an arrow A of FIG. 1 and the magnetic tape 1 is driven to the forward direction, the blade member 4 is in contact with the tape surface. Then, the movement of the magnetic tape 1 causes the contaminants 6, such as the stripped magnetic powder deposited on the tape surface and the dust coming from the external portion, to be shaven off by the blade member 4.

In succession, when the driving mechanism 5 is rotated to a direction indicated by an arrow B of FIG. 2 and the magnetic tape 1 is driven to the reverse direction, the power supply 7 of the solenoid serving as the blade moving mechanism 5 becomes on. The blade member 4 is pulled to the side of the blade moving mechanism on the basis of the movement of the solenoid. Thus, the blade member 4 is detached from the tape surface. So, the contaminants 6 shaven off by the blade member 4 are detached from the magnetic tape 1 together with the blade member 4, when the magnetic tape 1 is driven to the reverse direction. Hence, it is possible to prevent contaminants 6 is pulled back to the magnetic tape 1 and again deposited on the magnetic tape 1. Also, the contaminants 6 deposited on this blade member 4 are removed in the near future by the downward drop or the manual removal. Thus, it is further possible to prevent that the contaminants are returned back to the magnetic tape 1.

The above-mentioned operations enable the blade member 4 to come in contact with the magnetic tape 1 when the magnetic tape 1 is driven to the predetermined direction, and thereby enable the contaminants 6 on the magnetic tape 1 to be shaven off by the blade member 4. Thus, it is possible to write on and read from the magnetic tape 1, from which the contaminants 6 are removed, by the magnetic head, and further possible to prevent the occurrence of the writing/reading error.

When the magnetic tape is driven to a direction opposite to the above-mentioned direction, the blade member 4 is detached from the magnetic tape 1 by the blade moving mechanism 5. So, the contaminants 6, which are shaven off from the magnetic tape 1 and deposited on the blade member 4, can be prevented from being returned back to the magnetic tape 1. Thus, it is possible to reduce the occurrence of the situation in which the contaminants are sandwiched between the wound tapes. Hence, it is possible to prevent the magnetic tape 1 from being damaged.

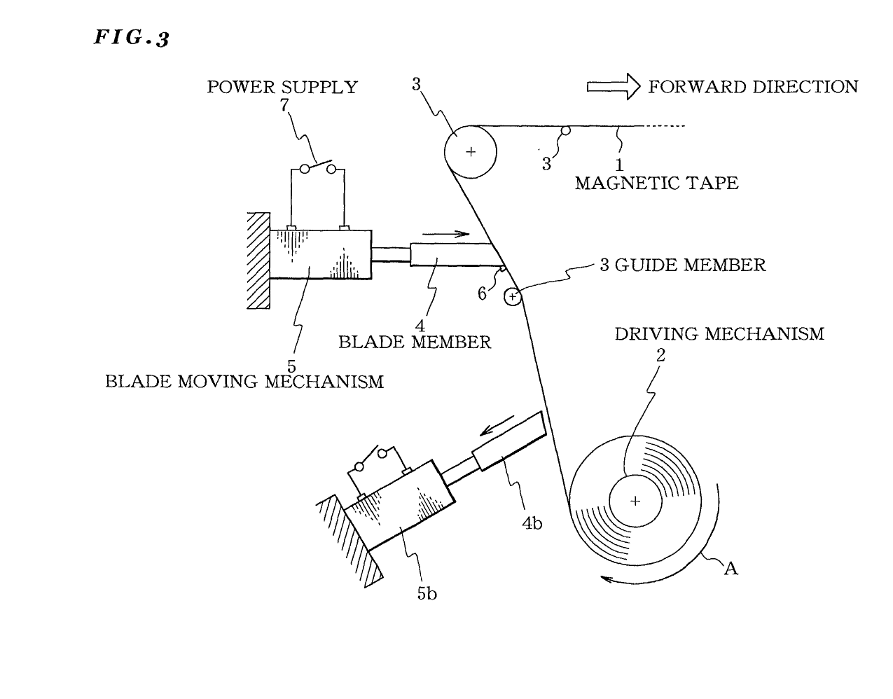

Here, in the embodiment, it exemplifies the case in the inclusion of one blade member 4 and one blade moving mechanism 5. However, it is not always limited to this case. As shown in FIG. 3, a plurality of blade members and a plurality of blade moving mechanisms may be installed. For example, in a case of two installations, the two blade moving mechanisms 5, 5b may be operated such that only one of the two blade members comes in contact the magnetic tape 1, on the base of the running direction of the magnetic tape. That is, when the magnetic tape 1 is driven to the forward direction, one blade member 4 comes in contact with the magnetic tape, and when the magnetic tape 1 is driven to the reverse direction, the other blade member 4b comes in contact with the magnetic tape. Thus, even if the magnetic tape 1 is driven to any of the directions, it is possible to clean the tape 1. Moreover, it is possible to prevent the once removed contaminants from being again deposited on the tape.

By the way, FIG. 3 shows the case in which the blade moving mechanisms 5, 5b are respectively separately installed. However, the present invention is not limited to it. That is, it may be designed that the respective blade moving mechanisms are mechanically linked to each other, and when one of the blades is in contact with the tape 1, the other blade is detached from the tape 1. This design enables the operations of the two blades to be simultaneously controlled by a single moving mechanism (single actuator) As explained above, the magnetic tape apparatus according to the present invention is provided with the magnetic head and the driving mechanism. It is also provided with: the blade member, which is located close to the magnetic tape, for cleaning the surface thereof when coming in contact with the magnetic tape; and the blade moving mechanism for holding this blade member and further moving the blade member irrespectively of the condition that the blade member is in contact with the magnetic tape or it is not in contact. So, when the magnetic tape is driven to the predetermined direction, the blade member is pushed by the blade moving mechanism so that it comes in contact with the recording/reproducing surface of the magnetic tape. Accordingly, the contaminants deposited on the tape surface are shaven off by the blade member. When the magnetic tape is driven to the reverse direction, the blade member is pulled by the blade moving mechanism so that it is detached from the magnetic tape. Thus, even if the shaven contaminants and the like are deposited to the blade member, it is possible to prevent the contaminants from being again deposited on the magnetic tape. Hence, it is possible to record on and reproduce from the magnetic tape, from which the contaminants are removed, through the magnetic head, and also possible to protect the contaminants from being put between the tape and the tape when it is wound. Hence, the damage to the tape can be effectively suppressed. Therefore, as mentioned above, the magnetic tape apparatus has the excellent effects which can not be provided by the conventional technique.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-386586 (Filed on Dec. 20, 2000) including specification, claims, drawings and summary are incorporated herein by reference in its entirety.

What is claimed is:

1. A magnetic tape apparatus comprising:
a magnetic head for writing/reading a predetermined data to/from a magnetic tape;
a driving mechanism for driving said magnetic tape;
a blade member for cleaning a surface of the magnetic tape; and
a blade moving mechanism for holding this blade member and further moving the blade member so as to contact/detach with/from said magnetic tape.

2. A magnetic tape apparatus according to claim 1,
wherein a moved direction of said blade member by said blade moving mechanism is a direction in which the blade member carries out a reciprocating motion against to the surface of said magnetic tape.

3. A magnetic tape apparatus according to claim 2,
wherein said blade moving mechanism moves the blade member so that when said magnetic tape is driven to a predetermined direction, said blade member comes in contact with the magnetic tape, and it moves the blade member so that when said magnetic tape is driven to a direction opposite to said predetermined direction, said blade member is detached from the magnetic tape.

4. A magnetic tape apparatus according to claim 3,
wherein said blade moving mechanism including a solenoid which carries out a reciprocating motion when a predetermined power supply is turned on and off, and said predetermined power supply is turned on and off on the basis of the driving direction of said magnetic tape.

5. A magnetic tape apparatus according to claim 3,
wherein two said blade members and two said blade moving mechanisms are installed close to said magnetic tape, and the two blade moving mechanisms are operated such that only one blade member of said two blade members comes in contact with the magnetic tape depending on the driving direction of said magnetic tape.

6. A magnetic tape apparatus according to claim 4,
wherein two said blade members and two said blade moving mechanisms are installed close to said magnetic tape, and the two blade moving mechanisms are operated such that only one blade member of said two blade members comes in contact with the magnetic tape depending on the driving direction of said magnetic tape.

7. A magnetic tape apparatus according to claim 1, wherein said blade member is made of hard material.

8. A magnetic tape apparatus according to claim 2, wherein said blade member is made of hard material.

9. A magnetic tape apparatus according to claim 3, wherein said blade member is made of hard material.

10. A magnetic tape apparatus according to claim 4,
wherein said blade member is made of hard material.

11. A magnetic tape apparatus according to claim 5,
wherein said blade member is made of hard material.

12. A magnetic tape apparatus according to claim 6,
wherein said blade member is made of hard material.

13. A magnetic tape apparatus according to claim 6,
wherein said blade moving mechanisms are linked each other, and said blade moving mechanisms are driven by a single actuator.
